(19) United States
(12) Patent Application Publication
(10) Pub. No.: US 2026/0134357 A1
(43) Pub. Date: May 14, 2026

(54) METHOD FOR ONLINE COORDINATED OPTIMIZATION SCHEDULING OF TRUCK MOBILE CHARGING STATIONS

(71) Applicants: Lanzhou Jiaotong University, Gansu (CN); Tianjin University, Tianjin (CN)

(72) Inventors: Kecheng HE, Gansu (CN); Hongjie JIA, Tianjin (CN); Yunfei MU, Tianjin (CN); Guangwu CHEN, Gansu (CN); Xiandong XU, Tianjin (CN); Xiaolong JIN, Tianjin (CN); Xiaodan YU, Tianjin (CN)

(73) Assignees: Lanzhou Jiaotong University, Gansu (CN); Tianjin University, Tianjin (CN)

(21) Appl. No.: 19/386,821

(22) Filed: Nov. 12, 2025

(30) Foreign Application Priority Data
Nov. 11, 2024 (CN) 202411599854.6

(51) Int. Cl. G06Q 10/04; B60L 53/64; G06Q 10/0631; G06Q 50/06

(52) U.S. Cl. CPC G06Q 10/04; B60L 53/64; G06Q 10/0631; G06Q 50/06

(57) ABSTRACT

Related to the field of charging infrastructure optimization, a method for online coordinated optimization scheduling of truck mobile charging stations. A two-stage framework is proposed: (1) offline training stage, where a multi-period optimization decision model for TMCSs is constructed, and a look-ahead rolling horizon-value function approximation (LRH-VFA) algorithm is then developed to iteratively learn from historical EV charging data, considering the impact of current-period decisions on future profit; and (2) online scheduling stage, where TMCS scheduling decisions are dynamically updated based on the approximate value function obtained from offline training, along with short-term forecasts and real-time information. The method effectively accounts for the impact of uncertain EV charging demand on TMCS scheduling, dynamically adjusting decisions based on real-time updates. It enables better coordination of TMCS online scheduling between EV charging services and energy arbitrage, improving operator profitability while ensuring the quality of charging services.

### CROSS-REFERENCE TO RELATED APPLICATIONS

The present application claims priority to Chinese Patent Application No. 202411599854.6, filed on Nov. 11, 2024, the content of all of which is incorporated herein by reference.

### FIELD

The present application relates to a method for online coordinated optimization scheduling of truck mobile charging stations, belonging to the field of charging facility optimization technology.

### BACKGROUND

According to the latest Global EV Outlook 2024 report from the International Energy Agency (IEA), global EV (electric vehicle) sales are expected to reach 17 million by 2024, accounting for more than one-fifth of global vehicle sales. Meanwhile, the number of public charging facilities remains insufficient, and a sixfold increase will be required by 2035 [1].

In fact, some limitations remain challenging for conventional public FCSs (fixed charging stations), including long construction periods, high expansion costs, and limited flexibility [2]. To address these issues, emerging TMCSs (truck mobile charging stations) are expected to offer a novel solution. TMCS integrates a certain number of chargers and a battery storage bank in a container carried by a truck. Since TMCS operates independently from the power grid and can be easily relocated, the TMCS is more flexible and scalable than FCS, enabling on-demand EV charging in various regions [2][3]. Reference [4] proposed a scheduling approach in which TMCSs are charged during low-price periods and dispatched to FCSs during peak queuing hours to provide EV charging services. Reference [5] developed a mixed-integer linear programming (MILP) model for TMCS scheduling and operator profit optimization, solved by an improved genetic algorithm. Reference [6] optimized the service locations of TMCSs using a flow-refueling location model. Reference [7] scheduled TMCSs to high-demand charging areas to reduce the peak load rate of FCSs. In addition, several studies have investigated the deployment of TMCSs in EV parking lots and their implications for social fairness in accessibility [8], as well as auction-based energy trading strategies between EVs and TMCSs [9]. Reference [10] proposed a day-ahead coordinated optimization framework to improve the utilization and economic performance of TMCSs during non-charging periods.

However, the above studies have not effectively addressed the charging uncertainty issue encountered during TMCS operation, resulting in actual performance often failing to achieve the expected optimization outcomes.

### REFERENCES

[1] IEA.Global EV outlook 2024 [EB/OL]. [2024 Apr. 23]. https://www.iea.org/reports/global-ev-outlook-2024.
[2] AFSHAR S, MACEDO P, MOHAMED F, et al. Mobile charging stations for electric vehicles—A review [J]. Renewable and Sustainable Energy Reviews, 2021, 152:111654.
[3] LIU L, QI X, XI Z, et al. Charging-Expense Minimization Through Assignment Rescheduling of Movable Charging Stations in Electric Vehicle Networks [J]. IEEE Transactions on Intelligent Transportation Systems, 2022, 23 (10): 17212-17223.
[4] Zheng Yuanshuo, Li Feng, Dong Jiuling, et al. Optimization and control strategy for spatiotemporal flexibility of mobile charging vehicles considering resource elastic sharing [J]. Automation of Electric Power Systems, 2023, 47 (14): 33-42.
[5] H. Li, D. Son, B. Jeong. Electric vehicle charging scheduling with mobile charging stations [J]. Journal of Cleaner Production, 2024, 434:140162.
[6] WANG F, CHEN R, MIAO L, et al. Location Optimization of Electric Vehicle Mobile Charging Stations Considering Multi-Period Stochastic User Equilibrium [J]. Sustainability, 2019, 11 (0): 5841.
[7] MOGHADDAM V, AHMAD I, HABIBI D, et al. Dispatch management of portable charging stations in electric vehicle networks [J]. eTransportation, 2021, 8:100112.
[8] NAZARI-HERIS M, LONI A, ASADI S, et al. Toward social equity access and mobile charging stations for electric vehicles: A case study in Los Angeles [J]. Applied Energy, 2022, 311:118704.
[9] THI KIM O T, LE T H T, SHIN M J, et al. Distributed Auction-Based Incentive Mechanism for Energy Trading Between Electric Vehicles and Mobile Charging Stations [J]. IEEE Access, 2022, 10:56331-56347.
[10] Jia Hongjie, He Kecheng, Mu Yunfei, et al. A collaborative optimization scheduling method for mobile charging stations: 202310938963.5[P]. 2024 Mar. 19.
[11] J. Liu, J, Wang, J, and Cardinal. Evolution and reform of UK electricity market [J]. Renewable and Sustainable Energy Reviews, 2022, 161, 112317.
[12] J. Yang, X. Jiang, K. Zhao. Multiobiective optimization method of location and capacity determination problems of highway charging stations [J]. Journal of Chongqing Normal University (Natural Science), 2021, 38(1), 11-21.
[13] K. He, H. Jia, Y. Mu, X. Yu, X. Dong and Y. Deng, “Coordinated planning of fixed and mobile charging facilities for electric vehicles on highways,” IEEE Trans. Intel. Transport. Syst., vol. 24, no. 9, pp. 10087-10098, September 2023.

### SUMMARY

The present application aims to overcome the shortcomings of the prior art by providing a method for online coordinated optimization scheduling of truck mobile charging stations (TMCSs). The proposed method fully considers the impact of the uncertainty of EV charging demand on TMCS scheduling results. By effectively utilizing dynamically updated demand information to adjust scheduling decisions, the method improves the revenue of charging facility operator (CFO) through coordinated energy arbitrage in the power grid, while ensuring the quality of charging services. It enables better coordination of TMCS online scheduling between EV charging services and energy arbitrage, improving operator profitability while ensuring reliable charging service for CFO.

To solve the above technical problems, the present application provides the following technical solution: a method for online coordinated optimization scheduling of TMCSs, which includes:
S1. Constructing a multi-period optimization decision model for TMCSs:

A set of TMCS operating locations is divided into a charging service node set and an energy arbitrage node set, and a multi-period optimization decision model for TMCSs is constructed.
S2. Reformulating MDP:

The multi-period optimization decision model for TMCSs is reformulated as a Markov Decision Process (MDP). Dynamic programming (DP) is adopted to solve the MDP by decomposing an original multi-period optimization problem into multiple continuous single-period optimization sub-problems that are solved iteratively.
S3. Constructing a two-stage lookahead rolling horizon-value function approximation (LRH-VFA) scheduling model:

A Look-ahead Rolling Horizon (LRH) algorithm is combined with an Approximate Dynamic Programming (ADP) algorithm to make full use of continuously updated real-time information, thereby defining a post-decision value function to quantify an impact of current decisions on CFO's future profit.

### Beneficial Effects

(1) The present application provides an online coordinated optimization scheduling framework for TMCSs to realize real-time coordinated scheduling between EV charging services and energy arbitrage.
(2) The proposed two-stage scheduling model based on the Look-ahead Rolling Horizon-Value Function Approximation (LRH-VFA) enables iterative learning from historical EV charging data to account for the impact of current decisions on future profit.
(3) The proposed optimization strategy explores the influence of EV charging demand uncertainty on TMCS scheduling. It enables outputting online coordinated optimization scheduling of TMCSs using only short-term predictions and real-time information during operation, thereby improving TMCS utilization and CFO profitability while ensuring service quality.

### BRIEF DESCRIPTION OF THE DRAWINGS

FIG. 1 is a framework of a method for online coordinated optimization scheduling of TMCSs.

FIG. 2 is a flowchart of LRH-VFA algorithm.

FIG. 3 is a flowchart of the method for online coordinated optimization scheduling of TMCSs.

FIG. 4 is a grid-form highway network and a distribution of related nodes.

FIG. 5 is a distribution of EVs departure time.

FIG. 6 is a OD (Origin-Destination) matrix of the grid-form highway network shown in FIG. 4.

FIG. 7 is an operation result of TMCSs in node 6 under test scenario of the grid-form highway network shown in FIG. 4.

FIG. 8 is an operation result of TMCS 3 under test scenario of the grid-form highway network shown in FIG. 4.

FIG. 9 is a ring-form highway network and a distribution of related nodes.

FIG. 10 is a OD matrix of the ring-form highway network shown in FIG. 9.

FIG. 11 is an operation result of TMCS 1 under test scenario of the ring-form highway network shown in FIG. 9.

### DETAILED DESCRIPTION OF EMBODIMENTS

The embodiments of the present application are described in detail below. It should be understood that the present application may be implemented in many different forms other than those explicitly described herein, and that various equivalent modifications may be made by those skilled in the art without departing from the spirit and scope of the present application. Therefore, the present application should not be limited to the embodiments disclosed herein.

Unless otherwise defined, all technical and scientific terms used herein have the same meaning as commonly understood by those skilled in the art to which the present application pertains. The terminology used in this description is intended only to describe particular embodiments and is not intended to limit the present application.

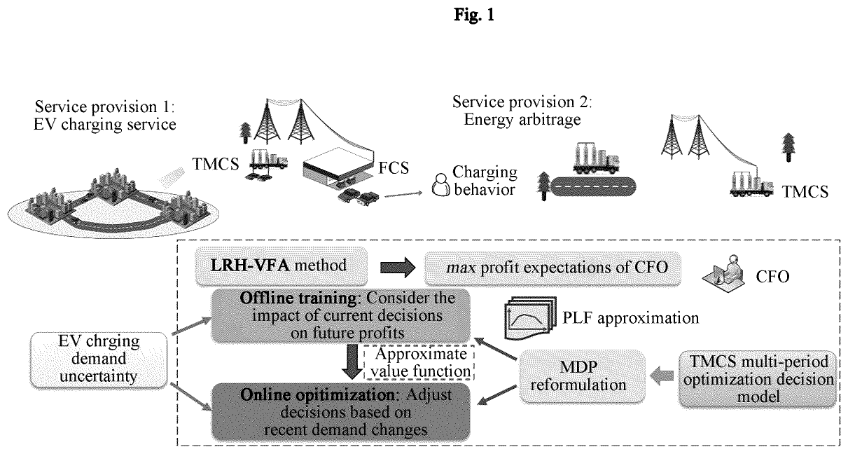

The operational framework of TMCS is depicted in FIG. 1 and the proposed method consists of two stages: (1) Offline training stage: Historical EV charging data are used to simulate charging demand patterns and their spatial-temporal variations. The multi-period optimization problem is reformulated as a Markov Decision Process (MDP) and decomposed into sequential subproblems. Piecewise linear function (PLF) is iteratively trained to capture the relationship between TMCS operation states and long-term profitability, embedding practical operational insights into the decision-making framework. (2) Online operation stage: TMCS coordinated scheduling results are updated on a rolling basis based on short-term simulation results of EV charging demand and the well-trained PLFs. The iteratively converged value function minimizes the impact of EV charging demand simulation errors on CFO profit in subsequent periods. The forward rolling output of each optimization result can further improve the quality of the solution with continuously updated real-time information. The construction of the multi-period optimization decision model for TMCSs.

In addition to supporting FCSs in providing EV charging services, TMCSs can also be scheduled to certain distribution network nodes during non-charging periods to participate in energy arbitrage for additional profit. In the present application, the set M of TMCS operating locations is divided into two disjoint subsets: M_{c} and Mₐ, where M_{c} represents the set of charging service nodes, and Mₐ represents the set of energy arbitrage nodes. m and u denote candidate locations for EV charging service nodes within a road network, while n and v denote candidate locations for energy arbitrage nodes where TMCS interact with a power grid. Z_{c} represents a transition process of TMCS between charging service nodes, Zₐ represents a transition process of TMCS between energy arbitrage nodes, and Zₑ represent a transition process of TMCS between a charging service node and an energy arbitrage node. Accordingly, a multi-period optimization decision model for TMCSs is constructed:

$${\sum }_{( m , u ) ∈ {Z}_{c}} {ζ}_{ω , mu}^{t} + {\sum }_{( n , v ) ∈ {Z}_{a}} {ζ}_{ω , nv}^{t} + {\sum }_{( m , n ) ∈ {Z}_{e} , m \neq n} {ζ}_{ω , mn}^{t} = 1 \qquad ( 1 )$$

$${\sum }_{( m , u ) ∈ {Z}_{c} , m \neq u} {ζ}_{ω , mu}^{t} + {\sum }_{( m , n ) ∈ {Z}_{e} , m \neq n} {ζ}_{ω , mn}^{t} \geq {ζ}_{ω , m m}^{t + 1} - {ζ}_{ω , m m}^{t} \qquad ( 2 )$$

$${\sum }_{( n , v ) ∈ {Z}_{a} , n \neq v} {ζ}_{ω , nv}^{t} + {\sum }_{( m , n ) ∈ {Z}_{e} , m \neq n} {ζ}_{ω , mn}^{t} \geq {ζ}_{ω , nn}^{t + 1} - {ζ}_{ω , nn}^{t} \qquad ( 3 )$$

$${D}_{ω} = {v}_{a} ( {\sum }_{( m , u ) ∈ {Z}_{c} , m \neq u} {ζ}_{ω , mu}^{t} + {\sum }_{( n , v ) ∈ {Z}_{a} , n \neq v} {ζ}_{ω , nv}^{t} + {\sum }_{( m , n ) ∈ {Z}_{e} , m \neq n} {ζ}_{ω , mn}^{t} ) \qquad ( 4 )$$

$${ζ}_{ω , nn}^{{t}_{e}} = 1 \qquad ( 5 )$$

where, ω refers to a TMCS number, ζ is a binary variable,

$${ζ}_{ω , mu}^{t} = 1 if T M C S ω$$

is on a path (m, u) at time t and 0 otherwise,

$${ζ}_{ω , m m}^{t} = 1 if T M C S ω$$

provides EV charging service at node m at time t and 0 otherwise,

$${ζ}_{ω , nn}^{t} = 1 if T M C S ω$$

performs energy arbitrage at node n at time t and 0 otherwise. D_{ω} is a total distance traveled by TMCS ω during time t, vₐ is an average moving speed of TMCS ω, and tₑ is an end service time for TMCS ω.

The formula (1) determines an operating state of each TMCS, i.e., whether it is located at a charging service node, an energy arbitrage node or in a moving state. Formulas (2) and (3) are constraints that present a transition relationship between providing charging service, performing energy arbitrage and moving. Formula (4) is a constraint that presents a total travel distance for each TMCS during scheduling period, and formula (5) is a constraint that defines a location of each TMCS when the service ends.

In the present application, road network information, power grid information, and TMCS configuration information are first obtained. The road network information includes locations of charging service nodes; the power grid information includes locations of energy arbitrage nodes; and the TMCS configuration information includes a current position of a TMCS, an average speed of the TMCS, and a final service location of the TMCS. Then, based on the TMCS configuration information, the road network information, and the power grid information, a current operating state of the TMCS and the total travel distance within the scheduling period are determined. The operating state includes providing EV charging service at a charging service node, performing energy arbitrage at an energy arbitrage node, and moving between nodes. Finally, based on the current operating state of the TMCS, a multi-period optimization decision model for TMCSs is generated. The road network information includes all possible charging service node locations, and the power grid information includes all possible energy arbitrage node locations. The charging service node location or energy arbitrage node location corresponding to the TMCS at the current time is determined according to the actual scheduling condition, so as to realize full-period optimization of the TMCS scheduling.

Further, considering the significant demand for FCSs and TMCSs as the EV charging load grows rapidly, TMCSs are required to meet the following power and state of charge (SOC) constraints during operations:

$$0 \leq {P}_{ch , ω n}^{t} \leq min ( {\sum }_{n ∈ {M}_{a}} {ζ}_{ω , nn}^{t} , {I}_{ch , ω}^{t} ) {P}_{ch , ω}^{max} \qquad ( 6 )$$

$$0 \leq {P}_{dch , ω n}^{t} \leq min ( {\sum }_{n ∈ {M}_{a}} {ζ}_{ω , nn}^{t} , {I}_{dch , ω}^{t} ) {P}_{dch , ω}^{max} \qquad ( 7 )$$

$${I}_{ch , ω}^{t} + {I}_{dch , ω}^{t} \leq {\sum }_{n ∈ {M}_{a}} {ζ}_{ω , nn}^{t} \qquad ( 8 )$$

$${P}_{dch , ω m}^{t} \leq {ζ}_{ω , m m}^{t} {P}_{cs , ω}^{max} \qquad ( 9 )$$

$${\sum }_{ω ∈ {Ω}_{m}^{c , t}} {P}_{dch , ω m}^{t} \geq max ( {P}_{m}^{t} - {ρ}^{c} {P}_{cs , ω}^{max} , 0 ) , {Ω}_{m}^{c , t} ⊆ Ω \qquad ( 10 )$$

$$S O {C}_{min} \leq S O {C}_{ω}^{t} \leq S O {C}_{max} \qquad ( 11 )$$

$$S O {C}_{ω}^{t + 1} = S O {C}_{ω}^{t} - \{ ( {\sum }_{n ∈ {M}_{a}} {P}_{dch , ω n}^{t + 1} + {\sum }_{m ∈ {M}_{c}} {P}_{dch , ω m}^{t + 1} ) / {η}_{dch , ω} - {η}_{ch , ω} {\sum }_{n ∈ {M}_{a}} {P}_{ch , ω n}^{t + 1} \} / {E}_{ω} \qquad ( 12 )$$

where, Ω is a set of TMCSs,

$${Ω}_{m}^{c , t}$$

is a set of TMCSs providing EV charging service at node m. ρ^{c} is an EV charging demand satisfied ratio of CFO, which reflects a charging service quality of the CFO.

$${P}_{ch , ω n}^{t}$$

is a charging power of TMCS ω while performing energy arbitrage at node n at time t,

$${P}_{dch , ω n}^{t}$$

is a discharging power of TMCS ω while performing energy arbitrage at node n at time t,

$${P}_{ch , ω}^{max}$$

is a maximum charging power of TMCS ω,

$${P}_{dch , ω}^{max}$$

is a maximum discharging power of TMCS ω,

$${P}_{m}^{t}$$

is a EV charging load at node m at time t,

$${P}_{dch , ω m}^{t}$$

is an output power of TMCS ω while providing charging service at node m at time t,

$${P}_{cs , ω}^{max}$$

is a maximum output power of TMCS ω while providing charging service.

$${I}_{ch , ω}^{t} and {I}_{dch , ω}^{t}$$

are binary variables, where

$${I}_{ch , ω}^{t} = 1$$

if TMCS ω is charging at time t,

$${I}_{dch , ω}^{t} = 1$$

if TMCS ω is discharging at time t,

$${I}_{ch , ω}^{t} = 0$$

if TMCS ω is not charging at time t, and

$${I}_{dch , ω}^{t} = 0$$

if TMCS ω is not discharging at time t. E_{ω} represents a capacity of TMCS ω, η_{ch,ω} represents a charging efficiency of TMCS ω, η_{dch,ω} represents a discharging efficiency of TMCS ω. SOCₘₐₓ is a maximum SOC value of TMCS, SOCₘᵢₙ is a minimum SOC value of TMCS,

$${SOC}_{ω}^{t}$$

represents a SOC value of TMCS ω at time t, and

$${SOC}_{ω}^{t + 1}$$

represents a SOC value of TMCS ω at time t+1.

Formulas (6) and (7) are constraints that establish a feasible charging and discharging power set of TMCS ω in energy arbitrage mode. Formula (8) is a constraint that defines charging and discharging constraints associated with the energy arbitrage mode. Formulas (9)-(10) are constraints that describe a feasible discharging power set of TMCS ω in EV charging service mode. Formulas (11) and (12) are SOC limitations, and the formula (11) determines the SOC of TMCS ω at the end of time t.

In the present application, firstly, a charging and discharging data of the TMCS, an EV charging demand satisfied ratio of CFO, and an EV charging load are obtained. The charging and discharging data includes: a maximum charging power of a TMCS, a maximum discharging power of the TMCS, a maximum output power of the TMCS while providing EV charging service, a capacity of the TMCS, a charging efficiency of the TMCS, a discharging efficiency of the TMCS, a maximum SOC value of the TMCS, and a minimum SOC value of the TMCS. Then, based on the operating state of the TMCS at the current time, the charging/discharging status of the TMCS at the current time is determined. Finally, based on the EV charging demand satisfied ratio of CFO, the EV charging load, the charging and discharging data of the TMCS, and the charging/discharging status of the TMCS at the current time, the following parameters are determined: a charging power of the TMCS during energy arbitrage at the current time, a discharging power of the TMCS during energy arbitrage at the current time, an output power of the TMCS during EV charging service at the current time, a SOC value of the TMCS at the current time, and a SOC value of the TMCS at the subsequent time.

An objective function of the multi-period optimization decision model for TMCSs is shown in formula (13).

$${max}_{{x}^{t}} f ( {x}^{t} ) = {\sum }_{t ∈ T} {\sum }_{ω ∈ Ω} \{ R ( {x}^{t} ) - {C}^{OM} ( {x}^{t} ) - {C}^{DEG} ( {x}^{t} ) \} \qquad ( 13 )$$

$$R ( {x}^{t} ) = {α}_{m}^{tmc} {P}_{dch , ω m}^{t} + {λ}_{n}^{t , d} {P}_{dch , ω n}^{t} - {λ}_{n}^{t , c} {P}_{ch , ω n}^{t} \qquad ( 14 )$$

$${C}^{O M} ( {x}^{t} ) = {λ}_{n}^{{t}_{e ,} c} {c}_{t m c} {D}_{ω} + {c}^{la} + {c}^{m t} \qquad ( 15 )$$

$${C}^{DEG} ( {x}^{t} ) = {c}^{mdc} + ( 1 + {r}_{0} ) κ ( t ) \{ {P}_{dch , ω m}^{t} + {P}_{dch , ω n}^{t} + {P}_{ch , ω n}^{t} + {q}^{t} \} \qquad ( 16 )$$

where, x^{t} is a decision variable,

$${α}_{m}^{tmc}$$

is a charging service fee,

$${λ}_{n}^{t , c}$$

is an energy arbitrage charging price,

$${λ}_{n}^{t , d}$$

is an energy arbitrage discharging price,

$${λ}_{n}^{{t}_{e} , c}$$

is a charging price when the TMCS ends operation and gets charged, c_{tmc} is an energy consumption per kilometer of TMCS, c^{la} is a labor cost converted to time t, c^{mt} is a maintenance cost converted to time t, c^{mdc} is a life-cycle marginal degradation cost to achieve the maximum life-cycle revenue of TMCS, q^{t} is a calendar degradation parameter of TMCS battery packs, r₀ is a discount rate, and κ(t) is a year order of time t since TMCS was put into service.

The formula (13) indicates that the optimization objective of the model is to maximize the profit of the CFO, and the profit equals to the everyday operation revenue R(dₜ) minus the O&M (operating and maintaining) cost C^{OM}(x^{t}) and the degradation cost C^{DEG}(x^{t}).

In the present application, firstly, cost information and cost parameters are obtained. The cost information includes: a charging service fee, a charging price for energy arbitrage, a discharging price for energy arbitrage, and an charging price for TMCS at the end of operation. The cost parameters include: an energy consumption per kilometer of the TMCS, a labor cost, a maintenance cost, a life-cycle marginal degradation cost of the TMCS, a calendar degradation parameter of TMCS battery packs, a discount rate, and a year order corresponding to when the TMCS was put into service. Then, based on the cost information, the cost parameters, the charging power and discharging power of the TMCS during energy arbitrage, the output power of the TMCS during EV charging service, and the total travel distance of the TMCS within the scheduling period, a total revenue, an O&M cost, and a degradation cost are determined. Finally, the multi-period optimization decision model for TMCSs is optimized based on the total revenue, the O&M cost, and the degradation cost, so as to maximize the profit of the CFO.

### The MDP Reformulation

The multi-period optimization decision model for TMCSs is a Mixed Integer Linear Programming (MILP) problem. Although the optimal solution to this optimization problem can be obtained, it requires complete and accurate state information of EV charging demand over the entire scheduling horizon at the time of decision-making. Due to the exogenous uncertainty of EV charging demand, such precise predictions are generally unavailable for real-time scheduling scenarios, which makes the MILP model unsuitable for real-time applications. Scenario-based and robust optimization methods are traditional and effective approaches for handling uncertainty and enhancing model robustness. The former relies on modeling uncertainties through probability distributions, while the latter focuses on ensuring solution feasibility under worst-case scenarios. However, both methods are inherently static and therefore cannot utilize updated changes in demand to dynamically adjust decisions.

In practice, during the online scheduling process of TMCSs, since the scheduling horizon (typically one day) is divided into T periods, the global optimal decision from the current period to the final period needs to be determined at each stage. Additionally, the current position and battery level already incorporate the impact of prior actions on the current state, indicating that the scheduling optimization problem exhibits the Markov property. Consequently, the present application reformulates the aforementioned multi-period optimization decision model for TMCSs as a Markov Decision Process (MDP) and then adopts dynamic programming (DP) to solve it. The present application decouples the original multi-period optimization problem into multiple sequential single-period optimization problems, while these problems can be solved iteratively and the transition function facilitates the progress between successive periods

In the present application, firstly, a current state variable, a current decision variable, and next-period exogenous information are obtained. The current state variable includes: a SOC value of the TMCS at a current time, a TMCS location in a previous period, and an EV charging load at the current time. The current decision variable includes: a charging power of TMCS while performing energy arbitrage at the current time, a discharging power of TMCS while performing energy arbitrage at the current time, a output power of TMCS while providing EV charging service at the current time, an operating state of the TMCS at the current time, and a charging/discharging state of TMCS at the current time. The next-period exogenous information includes: an estimated EV charging load at a next-period, a charging service fee at the next-period, a discharging price for energy arbitrage at the next-period, and a charging price for energy arbitrage at the next period. Then, based on the current state variable, the current decision variable, and the next-period exogenous information, a next-period state variable is obtained. Finally, the multi-period optimization decision model for TMCS is reformulated to model the MDP, and a Bellman equation is solved via dynamic programming to obtain an optimal decision sequence.

The MDP model mainly includes a state variable S^{t}, a decision variable x^{t}, and an exogenous variable W^{t}. The state variable represents a current state of the system, as shown in formula (17):

$${S}^{t} = \{ {SOC}_{ω}^{t} , {ζ}_{ω , mu}^{t - Δ t} , {ζ}_{ω , nv}^{t - Δ t} , {ζ}_{ω , mn}^{t - Δ t} , {P}_{m}^{t} \} \qquad ( 17 )$$

Given that the location information of the previous period affects the scheduling range of TMCSs in the subsequent period, the state variables considered in the present application include three binary variables:

$${ζ}_{ω , mu}^{t - Δ t} , {ζ}_{ω , nv}^{t - Δ t} and {ζ}_{ω , mn}^{t - Δ t} .$$

### Further,

$${ζ}_{ω , mu}^{t - Δ t} = 1$$

if TMCS ω is located between the nodes m and u at a previous period of time t,

$${ζ}_{ω , nv}^{t - Δ t} = 1$$

if TMCS ω is located between the nodes n and v at a previous period of time t,

$${ζ}_{ω , nn}^{t - Δ t} = 1$$

if TMCS ω is located between the nodes m and n at a previous period of time t,

$${ζ}_{ω , mu}^{t - Δ t} = 0$$

if TMCS ω is not located between the nodes m and u at a previous period of time t,

$${ζ}_{ω , nv}^{t - Δ t} = 0$$

if TMCS ω is not located between the nodes n and v at a previous period of time t, and

$${ζ}_{ω , mn}^{t - Δ t} = 0$$

if TMCS ω is not located between the nodes m and n at a previous period of time t.

$${P}_{m}^{t}$$

is a EV charging load at node m at time t, and

$${SOC}_{ω}^{t}$$

represents a SOC value of TMCS ω at time t, In the MDP model, the decision variable x^{t} is denoted as:

$${x}^{t} = \{ {P}_{ch , ω n}^{t} , {P}_{dch , ω n}^{t} , {P}_{dch , ω m}^{t} , {ζ}_{ω , mu}^{t} , {ζ}_{ω , nv}^{t} , {ζ}_{ω , mn}^{t} , {I}_{ch , ω}^{t} , {I}_{dch , ω}^{t} \} \qquad ( 18 )$$

Exogenous information is employed to model the error between the predicted and actual values of uncertain factors. The main sources of uncertainty include EV charging demand, adjustments in charging fees, and energy arbitrage price fluctuations. The exogenous information W^{t} is defined as:

$${W}^{t} = \{ {\hat{P}}_{m}^{t} , {α}_{m}^{tmc} , {λ}_{n}^{t , d} , {λ}_{n}^{t , c} \} \qquad ( 19 )$$

where,

$${\hat{P}}_{m}^{t}$$

is a predicted value of

$${P}_{m}^{t} .$$

From the time perspective, W^{t} denotes the stochastic information obtained after the end of the previous period (t−Δt) and before the current decision x^{t} is made. Therefore, the evolution of the decision process is as (W^{t}, S^{t}, x^{t}, W^{t+Δt}, S^{t+Δt}, x^{t+Δt}, . . . ), where, W^{t+Δt}, S^{t+Δt} and x^{t+Δt} are an exogenous variable at the next period of time t, a state variable at the next period of time t, and a decision variable at the next period of time t, respectively.

The transition function refers to the process by which the system transfers from the current state S^{t} to the next state S^{t+Δt} based on the decision x^{t} and the exogenous information W^{t+Δt}. Therefore, the transition function is defined as follows to obtain the state information of the system for the next time period.

$${S}^{t + Δ t} ( 1 ) = {S}^{t} ( 1 ) + \frac{Δ t}{{E}_{ω}} \{ {η}_{ch , ω} {\sum }_{n ∈ {M}_{a}} {x}^{t} ( 1 ) - ( {\sum }_{n ∈ {M}_{a}} {x}^{t} ( 2 ) + {\sum }_{m ∈ {M}_{c}} {x}^{t} ( 3 ) ) / {η}_{dch , ω} \} \qquad ( 20 )$$

$${S}^{t + Δ t} ( 2 ) = {x}^{t} ( 4 ) \qquad ( 21 )$$

$${S}^{t + Δ t} ( 3 ) = {x}^{t} ( 5 ) \qquad ( 22 )$$

$${S}^{t + Δ t} ( 4 ) = {x}^{t} ( 6 ) \qquad ( 23 )$$

$${S}^{t + Δ t} ( 5 ) = {P}_{m}^{t + Δ t} + {W}^{t + Δ t} ( 1 ) \qquad ( 24 )$$

where, Δt is a time interval, number in brackets of S^{t+Δt}(·) and S^{t}(·) corresponds to an order of parameter of S^{t} in the formula (17), i.e., S^{t+Δt}(·) and S^{t}(·) refers to parameters in corresponding position of S^{t}; number in brackets of x^{t}(·) corresponds to an order of parameter of x^{t} in the formula (18), i.e., x^{t}(·) refers to a parameter in corresponding position of x^{t}; number in brackets of W^{t+Δt}(·) corresponds to an order of parameter of W^{t+Δt} in the formula (19), i.e., W^{t+Δt}(·) refers to a parameter in corresponding position of W^{t+Δt}. Therefore, the formula of the objective function (13) is reformulated as:

$$F = {max}_{{x}^{t} ∈ {X}^{t}} E [ {\sum }_{t ∈ T} {f}^{t} ( {S}^{t} , {x}^{t} ) ] \qquad ( 25 )$$

$${f}^{t} ( {S}^{t} , {x}^{t} ) = R ( {S}^{t} , {x}^{t} ) - {C}^{OM} ( {S}^{t} , {x}^{t} ) - {C}^{DEG} ( {S}^{t} , {x}^{t} ) \qquad ( 26 )$$

where, E{·} represents performing expectation calculation, X^{t} represents a set of possible decisions. After reformulating the multi-period optimization decision model for TMCSs as the MDP, an optimal decision sequence can be obtained through the DP method by solving a Bellman equation:

$${V}^{t} ( {S}^{t} ) = {max}_{{x}^{t} ∈ {X}^{t}} \{ {f}^{t} ( {S}^{t} , {x}^{t} ) + γ E [ {V}^{t + Δ t} ( {S}^{t + Δ t} ) \vert {S}^{t} , {x}^{t} ] \} \qquad ( 27 )$$

where, V^{t} (S^{t}) is a value function, indicating a cumulative reward of the system in state S^{t} over the time interval Δt. ƒ^{t} represents the objective function, and γ is a discount factor that affects the weight of immediate and future rewards in the MDP, γ is set between 0 and 1.
   The construction of the two-stage LRH-VFA scheduling model

However, the DP algorithm faces challenges in enumerating the entire solution space due to the “curse of dimensionality” problem. In a stochastic environment, the system in a given state at the current stage may transition to any number of different states in the next stage, resulting in the “curse of dimensionality” problem, which makes it difficult to apply to real-time scheduling optimization of TMCS.

To address this, an Approximate Dynamic Programming (ADP) algorithm is employed to approximate the optimal solution of the original problem while ensuring the feasibility of online decision-making. ADP methods mainly include policy function approximation and value function approximation. For the latter, linear functions, piecewise linear functions (PLFs), look-up tables and nonparametric models can be used to approximate the value function. It is worth noting that energy arbitrage prices are usually available when making online scheduling decisions for TMCSs [11]. And the impact of charging fee adjustments on CFO profit is reflected as the change in SOC of TMCS. Studies have shown that for optimization problems involving energy storage, highly accurate results can be obtained by employing PLF with convex/concave properties to approximate the value function. In addition, we combine the rolling horizon strategy with the ADP algorithm to capitalize on the constantly updated and successively revealed real-time information since the transition and charging/discharging operation of TMCS may be hard to complete in one single time period. The value function of the post-decision state is defined to quantify the impact of the current decision on CFO's future profit:

$${V}^{t} ( {S}^{t} ) = {max}_{{x}^{{t}_{1}} , {x}^{{t}_{1} + Δ t} , ... , {x}^{{t}_{1} + ( H - 1 ) Δ t}} \{ {\sum }_{t = {t}_{1}}^{{t}_{1} + ( H - 1 ) Δ t} {f}^{t} ( {S}^{t} , {x}^{t} ) + γ {V}_{x}^{{t}_{1} + H Δ t} ( {S}_{x}^{{t}_{1} + H Δ t} ) \} \qquad ( 28 )$$

$${V}_{x}^{{t}_{1} + H Δ t} ( {S}_{x}^{{t}_{1} + H Δ t} ) = E [ {V}^{{t}_{1} + H Δ t} ( {S}^{{t}_{1} + H Δ t} ) \vert {S}^{{t}_{1} + ( H - 1 ) Δ t} ] \qquad ( 29 )$$

where,

$${S}_{x}^{t}$$

represents a state variable after the decision;

$${V}_{x}^{t} ( \cdot )$$

represents a value function of state after the decision, which denotes a state of the system after a decision is executed but before any random information is received. The optimization process of the state variable before the decision S^{t}, the decision x^{t}, the stochastic information (exogenous variable) W^{t}, and the state variable after the decision

$${S}_{x}^{t}$$

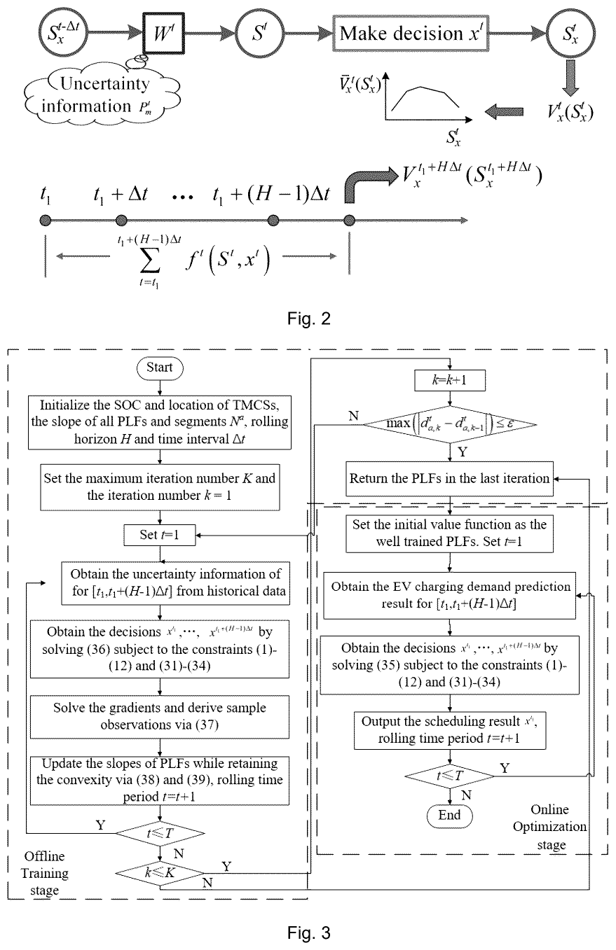

are illustrated in FIG. 2. Subsequently, the Bellman equation is rewritten as a PLF with monotonically increasing slopes:

$${V}_{x}^{{t}_{1} + H Δ t} ( {S}_{x}^{{t}_{1} + H Δ t} ) \approx {\overline{V}}_{x}^{{t}_{1} + H Δ t} ( {SOC}_{x}^{{t}_{1} + H Δ t} ) = {\sum }_{ω ∈ Ω , a ∈ {N}^{a}} {d}_{a , ω}^{{t}_{1}} {r}_{a , ω}^{{t}_{1}} \qquad ( 30 )$$

where, N^{α} represents a total number of segments in

$$PLF {\overline{V}}_{x}^{t} ( \cdot )$$

and a is a segment index;

$${SOC}_{x}^{t + H Δ t}$$

denotes a SOC value of TMCS after the decision; His a rolling horizon length set based on the reliability of short-term forecasts (preset rolling horizon length);

$${d}_{a , ω}^{{t}_{1}}$$

represents the slope for segment a of PLF;

$${r}_{a , ω}^{{t}_{1}}$$

represents a length of

$${SOC}_{x}^{t + Δ t}$$

projected onto the horizontal axis. In the present application,

$${\overline{{V}_{x}}}^{t} ( \cdot )$$

is divided into N^{α} segments, therefore, the following constraints need to be satisfied:

$${SOC}_{ω , x}^{{t}_{1} + H Δ t} = {\sum }_{a ∈ {N}^{a}} {r}_{a , ω}^{{t}_{1}} / {E}_{ω} \qquad ( 31 )$$

$$0 \leq {r}_{a , ω}^{{t}_{1}} \leq ( {E}_{ω}^{max} - {E}_{ω}^{min} ) / {N}^{a} \qquad ( 32 )$$

$${d}_{a , ω}^{{t}_{1}} \leq {d}_{a + 1 , ω}^{{t}_{1}} \qquad ( 33 )$$

$${SOC}_{ω}^{{t}_{1}} = {SOC}_{ω , x}^{{t}_{1} + H Δ t} + {\sum }_{t = {t}_{1}}^{{t}_{1} + ( H - 1 ) Δ t} \{ ( {\sum }_{n ∈ {M}_{a}} {P}_{dch , ω n}^{t} + {\sum }_{m ∈ {M}_{c}} {P}_{dch , ω m}^{t} ) / {η}_{dch , ω} - {η}_{ch , ω} {\sum }_{n ∈ {M}_{a}} {P}_{ch , ω n}^{t} \} / {E}_{ω} \qquad ( 34 )$$

where,

$${E}_{ω}^{max} and {E}_{ω}^{min}$$

refer to maximum and minimum energy storage capacity of TMCS ω, respectively; t₁ is a start time period;

$${SOC}_{ω}^{{t}_{1}}$$

denotes the SOC of TMCS ω before the decision x^{t}^{₁} is executed. The formula (31) indicates that the TMCS energy equals the sum of the values in each segment. The formula (32) ensures that the values in each segment do not exceed the upper and lower limits. The formula (33) ensures that the slope increases monotonically with the segment number, thereby guaranteeing that PLF is a convex function. The formula (34) represents the change relationship of SOC of TMCS ω before and after the decision. Furthermore, an approximate optimal decision x̅^{t}^{₁} can be obtained by recursively solving the following formula:

$${\overline{x}}^{{t}_{1}} = arg {max}_{{x}^{{t}_{1}} , {x}^{{t}_{1} + Δ t} , ... , {x}^{{t}_{1} + ( H - 1 ) Δ t}} ( {\sum }_{t = {t}_{1}}^{{t}_{1} + ( H - 1 ) Δ t} {f}^{t} ( {S}^{t} , {x}^{t} ) + γ {\sum }_{ω ∈ Ω , a ∈ {N}^{a}} {d}_{a , ω}^{{t}_{1} + H Δ t} {r}_{a , ω}^{{t}_{1} + H Δ t} \vert {S}_{x}^{{t}_{1} + ( H - 1 ) Δ t} ) \qquad ( 35 )$$

The optimality of the model depends on how close the approximate value function is to the true value function, which in turn depends strongly on the slopes of the segments in the PLF. To ensure the best possible decisions, a differential iteration method is employed to train and update the slopes of the PLF segments. It is noteworthy that after the (k−1)-th iteration, the PLF function

$${\overline{V}}_{x}^{{t}_{1} + H Δ t , k - 1}$$

corresponding to each time period is known. Thus, the formula (35) in the k-th iteration can be rewritten as formula (36), then the slope sample value of

$${\overline{V}}_{x}^{{t}_{1} , k}$$

is defined as formula (37), and the slope of the PLF is updated as formula (38):

$${\overline{x}}_{k}^{{t}_{1}} = arg {max}_{{x}^{{t}_{1}} , {x}_{k}^{{t}_{1}} , {x}_{k}^{{t}_{1} + Δ t} , … , {x}_{k}^{{t}_{1} + ( H - 1 ) Δ t}} ( {\sum }_{t = {t}_{1}}^{{t}_{1} + ( H - 1 ) Δ t} {f}^{t} ( {S}_{k}^{t} , {x}_{k}^{t} ) + γ {\sum }_{ω ∈ Ω , a ∈ {N}^{a}} {d}_{a , ω , k - 1}^{{t}_{1} + H Δ t} {r}_{a , ω , k}^{{t}_{1} + H Δ t} \vert {S}_{x , k}^{{t}_{1} + ( H - 1 ) Δ t} ) \qquad ( 36 )$$

$${\hat{d}}_{a , k}^{{t}_{1}} ( {SOC}_{x , k}^{{t}_{1}} ) = \partial {max}_{{x}^{{t}_{1} + ( H - 1 ) Δ t} , … , {x}^{{t}_{1} + ( H - 1 ) Δ t}} ( {\sum }_{t = {t}_{1}}^{{t}_{1} + ( H - 1 ) Δ t} {f}^{t} ( {S}_{k}^{t} , {x}_{k}^{t} ) + γ {\sum }_{ω ∈ Ω , a ∈ {N}^{a}} {d}_{a , ω , k - 1}^{{t}_{1} + H Δ t} {r}_{a , ω , k}^{{t}_{1} + H Δ t} ) / \partial {SOC}_{k}^{{t}_{1}} \qquad ( 37 )$$

$${d}_{a , k}^{{t}_{1}} ( {SOC}_{x , k}^{{t}_{1}} ) = ( 1 - {θ}_{k - 1} ) {d}_{a , k - 1}^{{t}_{1}} ( {SOC}_{x , k}^{{t}_{1}} ) + {θ}_{k - 1} {\hat{d}}_{a , k}^{{t}_{1}} ( {SOC}_{x , k}^{{t}_{1}} ) \qquad ( 38 )$$

where,

$${\overline{x}}_{k}^{{t}_{1}}$$

represents the approximate optimal decision in the k-th iteration;

$${d}_{a , k - 1}^{t} ( S O {C}_{x , k}^{t} )$$

denotes the slope value of segment a in the PLF at the (k−1)-th iteration;

$${\hat{d}}_{a , k}^{{t}_{1}} ( S O {C}_{x , k}^{{t}_{1}} )$$

represents a gradient of the state variable at k-th iteration; and θₖ₋₁ is an updating interval of the slope. It can be seen that the slope of PLF represents the impact of TMCS unit energy changes on the subsequent period profit of CFO. To ensure that the updated slopes still satisfy the monotonically increasing property, the leveling algorithm is employed to update the slope values of each segment:

$${d}_{b , k}^{{t}_{1}} = \{ \begin{matrix}max \{ {d}_{b , k - 1}^{{t}_{1}} , ( 1 - {θ}_{k - 1} ) {d}_{a , k - 1}^{{t}_{1}} + {θ}_{k - 1} {\hat{d}}_{a , k}^{{t}_{1}} \} , b > a \\ ( 1 - {θ}_{k - 1} ) {d}_{a , k - 1}^{{t}_{1}} + {θ}_{k - 1} {\hat{d}}_{a , k}^{{t}_{1}} , b = a \\ min \{ {d}_{b , k - 1}^{{t}_{1}} , ( 1 - {θ}_{k - 1} ) {d}_{a , k - 1}^{{t}_{1}} + {θ}_{k - 1} {\hat{d}}_{a , k}^{{t}_{1}} \} , b < a\end{matrix} \qquad ( 39 )$$

where,

$${d}_{b , k}^{{t}_{1}}$$

represents a slope corresponding to segment b after the k-th iteration.

The flowchart of the real-time optimization scheduling method for TMCSs is shown in FIG. 3.

As shown in FIG. 3, in the offline training stage, the following parameters are first set: a SOC position of a TMCS, an initial slope and segments number of PLF, a preset rolling horizon length, a convergence tolerance, a time interval, and a maximum number of iterations. Then, training scenarios are generated using the Monte Carlo Simulation (MCS) method, and the current time period is set to 1. After obtaining uncertain information from historical data, the formulas (1)-(12) and (31)-(34) are substituted into the formula (36) to obtain a decision sequence. Subsequently, a gradient is solved according to formula (37) to derive sample observations, and slope values of each segment are updated using the formulas (38) and (39) to ensure the convexity of PLF. If the current time period corresponds to the end of operation and the maximum number of iterations has been reached, or if the slope difference between two consecutive iterations falls within the preset convergence range (E), the PLF obtained from the last iteration is output and used in the online optimization stage.

In the online optimization stage, the obtained PLF is employed as an approximate value function, and the current time period is again set to 1. The charging demand prediction result is acquired, and the formulas (1)-(12) and (31)-(34) are substituted into the formula (35) to solve for the decision sequence. The scheduling results are then output, and the process proceeds to the next time period. The online optimization continues until the end of the operation period, at which point the optimization process terminates.

Furthermore, the present application implements the method for online coordinated optimization scheduling of truck mobile charging stations (TMCSs) through an online scheduling system, wherein the system includes:

An information acquisition module, configured to acquire road network information from a road network management platform, power grid information from a power grid monitoring platform, and TMCS operation parameters from an onboard control unit. The road network information includes geographical locations of charging nodes and connectivity relationships within the road network; the power grid information includes locations of nodes available for energy arbitrage and corresponding electricity price information; and the TMCS operation parameters include the current positions of TMCSs, the average speed, and the locations planned to end the service.

A state determination module, wherein the information acquisition module transmits the acquired road network information, power grid information, and TMCS operation parameters to the state determination module for real-time determination of the current operating states of TMCSs, and for calculating the feasible travel distance of TMCSs within the predefined scheduling period;

A scheduling module, wherein the state determination module transmits the current operating states of TMCSs to the scheduling module. The scheduling module dynamically generates multi-period scheduling decision data based on the operating states, energy demand, electricity price information, and traffic accessibility within the corresponding period. The scheduling module then generates scheduling instructions according to the multi-period scheduling decision data, which are then sent to the corresponding TMCS to guide its subsequent route selection and charging/discharging operations.

The online scheduling system performs real-time scheduling of the traveling path and charging/discharging operations of the TMCSs during operation, thereby achieving global optimization of TMCS operation and improving energy utilization efficiency across the entire time domain, while ensuring the overall profit of the CFO under the premise of maintaining the required service quality.

### EMBODIMENTS

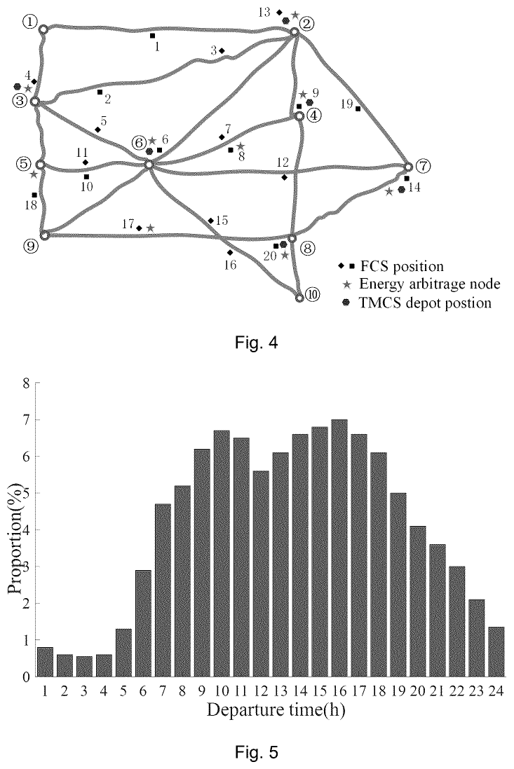

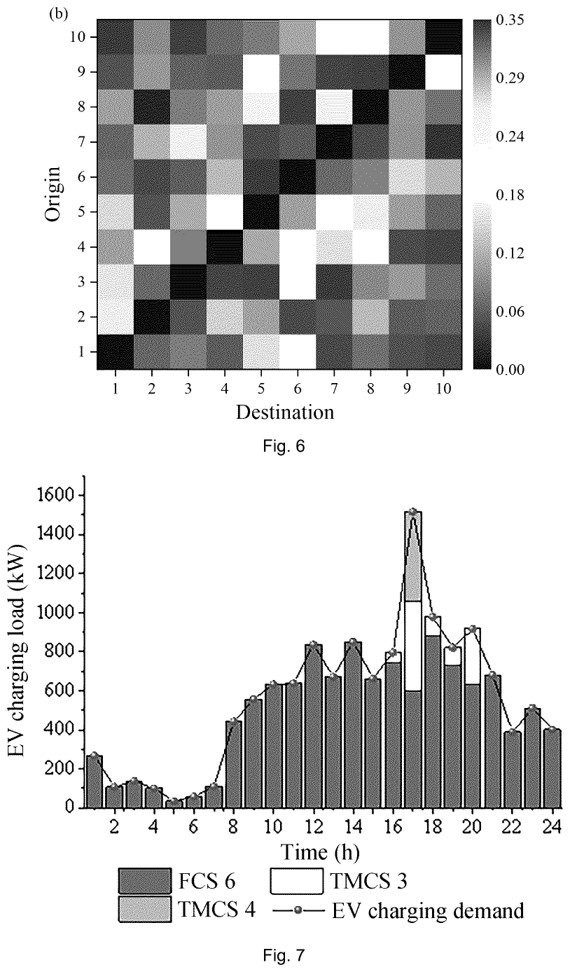

One embodiment of the present application is validated using a grid-form highway network described in reference [12](as shown in FIG. 4). The network consists of 10 nodes and 18 paths, where the CFO operates 20 FCSs and 6 TMCSs. Detailed data are provided in FIG. 5, FIG. 6, Table 1 and Table 2. The load price follows a typical time-of-use (TOU) electricity pricing scheme, and other parameters are listed in Table 3.

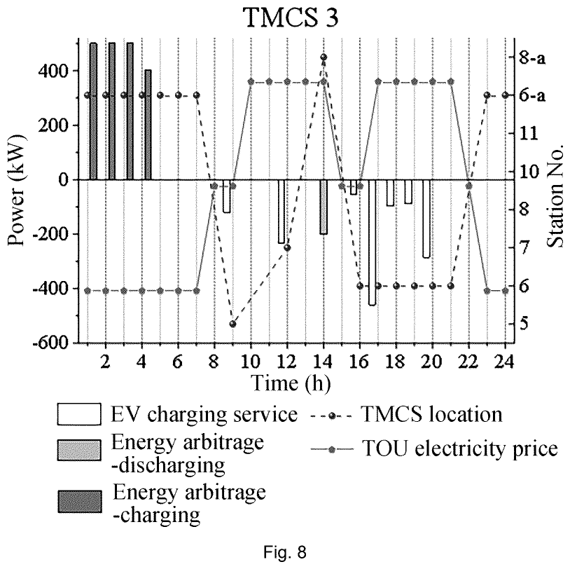

In the present embodiment, the scheduling results of one test scenario are illustrated in FIG. 7 and FIG. 8. As shown in FIG. 7 and FIG. 8, TMCS 3, TMCS 4, and FCS 6 correspond to a specific TMCS or FCS, while 8-a and 6-a on the right vertical axis of FIG. 8 correspond to arbitrage node 8 and arbitrage node 6 in FIG. 4. The averaged results from 200 test scenarios are summarized in Table 4. As shown in Table 4, compared with the MILP model in the prior art (i.e., the Benchmark Model, representing the optimal reference solution), the profit gap of the method in the present embodiment is only 3.67%, while the computation time is less than 2 minutes. These results indicate that the proposed approach can fully satisfy the requirements of real-time online optimization scheduling for TMCSs, improving operator profitability while ensuring reliable charging service for CFO.

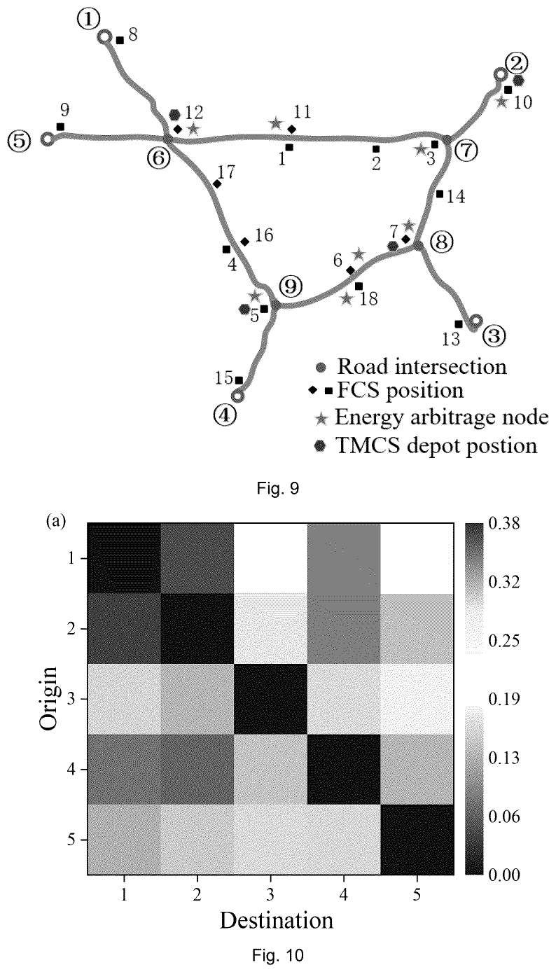

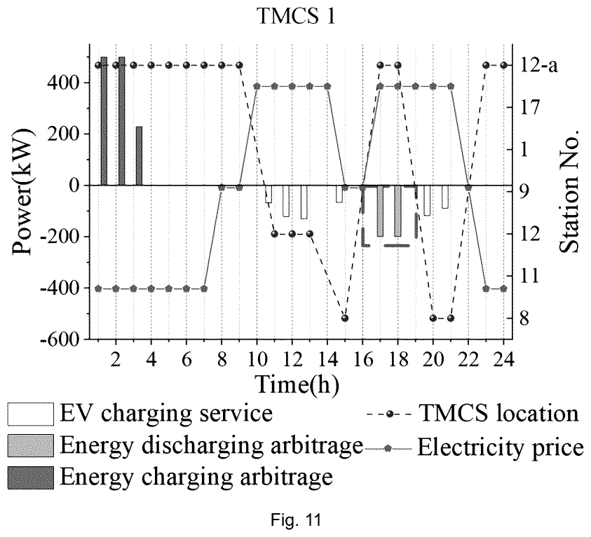

Another embodiment of the present invention is validated using the ring-form highway network described in reference [13](as shown in FIG. 9). This network consists of 9 nodes and 9 paths, including five entry/exit nodes and five inner-ring nodes, simulating the topological structure of a modern metropolitan area. The CFO operates 18 FCSs and 4 TMCSs, with detailed data shown in Table 5, Table 6, FIG. 5 and FIG. 10. The load price again follows a typical TOU pricing scheme, and other parameters are given in Table 3.

The scheduling results of TMCS 1 in a weekday test scenario are shown in FIG. 11, where TMCS 1 corresponds to a specific TMCS, and 12-a on the right vertical axis of FIG. 11 corresponds to arbitrage node 12 in FIG. 9. To evaluate the performance of the proposed LRH-VFA algorithm, 200 test scenarios were generated using Monte Carlo simulation. Taking the MILP model as the benchmark, the results of the proposed model were compared with those of the Myopic Strategy, Rolling Horizon (RH) Strategy, and Value Function Approximation (VFA) Strategy. As shown in Table 7, under the weekday test scenario, the Myopic and RH models in the prior art only focus on current or near-term optimization and therefore fail to yield globally optimal solutions. The VFA model improves the coordination of TMCS services but still shows a relatively large performance gap from the optimal benchmark (gap=5.82%). In contrast, the method in the present embodiment iteratively approximates the CFO's future profit, achieving a near-optimal global solution with the smallest gap (2.31%). Furthermore, in the present embodiment, the computation time remains within the practical operational range, demonstrating that the method can meet the real-time online optimization scheduling requirements for TMCSs while maintaining the charging service quality required by the CFO.

Overall, the results indicate that the present application can effectively meet the real-time operational control requirements of large-scale TMCS systems, providing an approximately globally optimal online scheduling solution. The proposed method can better coordinate TMCS operations between EV charging services and energy arbitrage, thereby improving both charging service quality and CFO's profit. TMCSs can be flexibly dispatched to regions with high charging demand and relocated in response to real-time demand fluctuations, offering a flexible and scalable solution to meet the evolving needs of dynamic EV charging services and the energy market.

TABLE 1
Parameters of the grid-form highway network

| O-D | Distance/km |
|---|---|
| 1-2 | 300 |
| 1-3 | 100 |
| 2-3 | 240 |
| 2-4 | 60 |
| 2-6 | 160 |
| 2-7 | 220 |
| 3-5 | 110 |
| 3-6 | 100 |
| 4-6 | 120 |
| 4-8 | 110 |
| 5-6 | 120 |
| 5-9 | 90 |
| 6-7 | 280 |
| 6-9 | 80 |
| 6-10 | 230 |
| 7-8 | 120 |
| 8-9 | 190 |
| 8-10 | 70 |

TABLE 2
Number of chargers per FCS in the grid-form highway network

| Station No. | Chargers |
|---|---|
| 1 | 12 |
| 2 | 10 |
| 3 | 16 |
| 4 | 13 |
| 5 | 12 |
| 6 | 14 |
| 7 | 10 |
| 8 | 16 |
| 9 | 12 |
| 10 | 18 |
| 11 | 19 |
| 12 | 27 |
| 13 | 12 |
| 14 | 23 |
| 15 | 21 |
| 16 | 18 |
| 17 | 16 |
| 18 | 22 |
| 19 | 19 |
| 20 | 28 |

TABLE 3
Parameters for simulation

| Parameter | Value | Unit | Parameter | Value | Unit | Parameter | Value | Unit |
|---|---|---|---|---|---|---|---|---|
| ${α}_{m}^{tmc}$ | 3 | ¥/kWh | ${E}_{ω}^{tmc}$ | 3000 | kWh | q^{t} | 1000 | kWh/day |
| c^{la} | 200 | ¥/day | SOCₘₐₓ | 0.9 | / | γ | 1 | / |
| c^{mt} | 30 | ¥/day | SOCₘᵢₙ | 0.15 | / | ρ^{c} | 0.1 | / |
| c^{mdc} | 50 | $/MWh | H | 2 | hour | rₒₑ | 7 | ¥/$ |
| ${P}_{cs , ω}^{max}$ | 800 | kW | n_{ch,ω} | 0.9 | / | r₀ | 6 | % |
| ${P}_{ch , ω}^{max}$ | 500 | kW | n_{dch,ω} | 0.9 | / | X_{tmc} | 1.25 | kwh/km |
| ${P}_{dch , ω}^{max}$ | 200 | kW | tₑ | 23 | | κ(t) | 1 | / |

TABLE 4
Results of the grid-form highway network

| | Average | | | Average |
|---|---|---|---|---|
| | profit | Average | Average | calculation |
| Model | (¥10³) | gap (%) | ρ (%) | time (s) |
| The present | 13.08 | 3.67 | 43.05 | 113.34 |
| application | | | | |
| MILP model in the | 13.58 | / | 38.26 | 8.97 |
| prior art | | | | |

TABLE 5
Parameters of the ring-form highway network

| Node | Coordinate | O-D | Distance/km |
|---|---|---|---|
| 1 | (40, 135) | 1-6 | 40.31 |
| 2 | (180, 120) | 2-7 | 28.28 |
| 3 | (175, 35) | 3-8 | 35.36 |
| 4 | (90, 10) | 4-9 | 31.62 |
| 5 | (20, 100) | 5-6 | 40.00 |
| 6 | (60, 100) | 6-7 | 100.00 |
| 7 | (160, 100) | 6-9 | 72.11 |
| 8 | (150, 60) | 7-8 | 41.23 |
| 9 | (100, 40) | 8-9 | 53.85 |

TABLE 6
Number of chargers per FCS in the ring-form highway network

| Station No. | Chargers |
|---|---|
| 1 | 14 |
| 2 | 13 |
| 3 | 12 |
| 4 | 21 |
| 5 | 17 |
| 6 | 18 |
| 7 | 12 |
| 8 | 9 |
| 9 | 10 |
| 10 | 8 |
| 11 | 20 |
| 12 | 22 |
| 13 | 9 |
| 14 | 18 |
| 15 | 16 |
| 16 | 22 |
| 17 | 23 |
| 18 | 23 |

TABLE 7
Results of the ring-form highway network

| | | | | | | Average |
|---|---|---|---|---|---|---|
| | | Average | | | | calcula- |
| Test | | profit | Average | Average | Average | tion time |
| scenario | Model | (¥10³) | gap (%) | ρ (%) | δ (%) | (s) |
| Week- | Myopic | 1.89 | 18.35 | 45.71 | 78.25 | 5.10 |
| day | RH | 2.12 | 8.65 | 53.10 | 74.62 | 10.43 |
| | VFA | 2.18 | 5.82 | 58.62 | 76.88 | 5.71 |
| | The present | 2.27 | 2.31 | 62.66 | 73.17 | 12.12 |
| | application | | | | | |

The technical features of the above embodiments can be combined in any way. For the sake of brevity, not all possible combinations of the technical features in the above embodiments are exhaustively listed. However, as long as there is no contradiction in the combination of these technical features, such combinations should be considered to be within the scope of this specification.

For those skilled in the art, various modifications and improvements can be made without departing from the concept of the present application, and these modifications and improvements are all within the scope of protection of the present application. The scope of protection of the present invention is defined by the appended claims.

What is claimed is:

1. A method for online coordinated optimization scheduling of truck mobile charging stations (TMCSs), comprising:
S1, constructing a multi-period optimization decision model for TMCSs, comprising:
dividing a set of TMCS operating locations into a charging service node set and an energy arbitrage node set, and constructing a multi-period optimization decision model for TMCSs
S2, reformulating Markov decision process (MDP), comprising:
reformulating the multi-period optimization decision model for TMCSs to model a Markov decision process (MDP); adopting dynamic programming (DP) to solve the MDP by decomposing an original multi-period optimization problem into multiple continuous single-period optimization sub-problems that are solved iteratively; and
S3, constructing two-stage lookahead rolling horizon-value function approximation (LRH-VFA) scheduling model, comprising:
combining a LRH algorithm with an ADP algorithm to make full use of continuously updated real-time information, thereby defining a post-decision value function to quantify an impact of current decisions on CFO's future profit.

2. The method according to claim 1, wherein in step S1, the set M of TMCS operating locations is divided into two disjoint subsets: M_{c} and Mₐ, wherein M_{c} represents the set of charging service nodes, and Mₐ represents the set of energy arbitrage nodes. m and u denote candidate locations for EV charging service nodes within a road network, while n and v denote candidate locations for energy arbitrage nodes where TMCS interact with a power grid. Zₑ represents a transition process of TMCS between charging service nodes, Zₐ represents a transition process of TMCS between energy arbitrage nodes, and Zₑ represent a transition process of TMCS between a charging service node and an energy arbitrage node, accordingly, the multi-period optimization decision model for TMCSs is constructed:
$${\sum }_{( m , u ) ∈ {Z}_{c}} {ζ}_{ω , mu}^{t} + {\sum }_{( n , v ) ∈ {Z}_{a}} {ζ}_{ω , nv}^{t} + {\sum }_{( m , n ) ∈ {Z}_{e} , m \neq n} {ζ}_{ω , mn}^{t} = 1 \qquad ( 1 )$$
$${\sum }_{( m , u ) ∈ {Z}_{c} , m \neq u} {ζ}_{ω , mu}^{t} + {\sum }_{( m , n ) ∈ {Z}_{e} , m \neq n} {ζ}_{ω , mn}^{t} \geq {ζ}_{ω , mm}^{t + 1} - {ζ}_{ω , mm}^{t} \qquad ( 2 )$$
$${\sum }_{( n , v ) ∈ {Z}_{a} , n \neq v} {ζ}_{ω , nv}^{t} + {\sum }_{( m , n ) ∈ {Z}_{e} , m \neq n} {ζ}_{ω , mn}^{t} \geq {ζ}_{ω , nn}^{t + 1} - {ζ}_{ω , nn}^{t} \qquad ( 3 )$$
$${D}_{ω} = {v}_{a} ( {\sum }_{( m , u ) ∈ {Z}_{c} , m \neq u} {ζ}_{ω , mu}^{t} + {\sum }_{( n , v ) ∈ {Z}_{a} , n \neq v} {ζ}_{ω , nv}^{t} + {\sum }_{( m , n ) ∈ {Z}_{e} , m \neq n} {ζ}_{ω , mn}^{t} ) \qquad ( 4 )$$
$${ζ}_{ω , nn}^{{t}_{e}} = 1 \qquad ( 5 )$$
wherein, ω refers to a TMCS number, ζ is a binary variable,
$${ζ}_{ω , mu}^{i} = 1$$
if TMCS ω is on a path (m, u) at time t and 0 otherwise,
$${ζ}_{ω , mm}^{t} = 1$$
if TMCS ω provides EV charging service at node m at time t and 0 otherwise,
$${ζ}_{ω , nn}^{t} = 1$$
if TMCS ω performs energy arbitrage at node n at time t and 0 otherwise. D_{ω} is a total distance traveled by TMCS ω during time t, vₐ is an average speed of TMCS ω, and tₑ is an end service time for TMCS ω.

3. The method according to claim 2, wherein the TMCS is constrained by:
$$0 \leq {P}_{c h , ω n}^{t} \leq min ( {\sum }_{n ∈ {M}_{a}} {ζ}_{ω , n n}^{t} , {I}_{c h , ω}^{t} ) {P}_{c h , ω}^{max} \qquad ( 6 )$$
$$0 \leq {P}_{d c h , ω n}^{t} \leq min ( {\sum }_{n ∈ {M}_{a}} {ζ}_{ω , nn}^{t} , {I}_{dch , ω}^{t} ) {P}_{dch , ω}^{max} \qquad ( 7 )$$
$${I}_{c h , ω}^{t} + {I}_{dch , ω}^{t} \leq {\sum }_{n ∈ {M}_{a}} {ζ}_{ω , n n}^{t} \qquad ( 8 )$$
$${P}_{d c h , ω m}^{t} \leq {ζ}_{ω , mm}^{t} {P}_{c s , ω}^{max} \qquad ( 9 )$$
$${\sum }_{ω ∈ {Ω}_{m}^{c , t}} {P}_{d c h , ω m}^{t} \geq max ( {P}_{m}^{t} - {ρ}^{c} {P}_{c h , ω}^{max} , 0 ) , {Ω}_{m}^{c , t} ⊆ Ω \qquad ( 10 )$$
$${SOC}_{min} \leq S O {C}_{ω}^{t} \leq {SOC}_{max} \qquad ( 11 )$$
$${SOC}_{ω}^{t + 1} = S O {C}_{ω}^{t} - \{ ( {\sum }_{n ∈ {M}_{a}} {P}_{dch , ω n}^{t + 1} + {\sum }_{m ∈ {M}_{c}} {P}_{d c h , ω m}^{t + 1} ) / {η}_{d c h , ω} - {η}_{c h , ω} {\sum }_{n ∈ {M}_{a}} {P}_{ch , ω n}^{t + 1} \} / {E}_{ω} \qquad ( 12 )$$
wherein, Ω is a set of TMCSs,
$${Ω}_{m}^{c , t}$$
is a set of TMCSs providing EV charging service at node m. ρ^{c} is an EV charging demand satisfied ratio of charging facility operator (CFO), which reflects a charging service quality of the CFO;
$${P}_{ch , ω n}^{t}$$
is a charging power of TMCS ω while performing energy arbitrage at node n at time t,
$${P}_{dch , ω n}^{t}$$
is a discharging power of TMCS ω while performing energy arbitrage at node n at time t,
$${P}_{ch , ω}^{max}$$
is a maximum charging power of TMCS ω,
$${P}_{dch , ω}^{max}$$
is a maximum discharging power of TMCS ω,
$${P}_{m}^{t}$$
is a EV charging load at node m at time t,
$${P}_{d c h , ω m}^{t}$$
is an output power of TMCS ω while providing charging service at node m at time t,
$${P}_{ch , ω}^{max}$$
is a maximum output power of TMCS ω while providing charging service.
$${I}_{ch , ω}^{t} and {I}_{dch , ω}^{t}$$
are binary variables, wherein
$${I}_{ch , ω}^{t} = 1$$
if TMCS ω is charging at time t,
$${I}_{dch , ω}^{t} = 1$$
if TMCS ω is discharging at time t,
$${I}_{ch , ω}^{t} = 0$$
if TMCS co is not charging at time t, and
$${I}_{dch , ω}^{t} = 0$$
if TMCS ω is not discharging at time t; E_{ω} represents a capacity of TMCS ω, η_{ch, ω} represents a charging efficiency of TMCS ω, η_{dch, ω} represents a discharging efficiency of TMCS ω; SOCₘₐₓ is a maximum SOC value of TMCS, SOCₘᵢₙ is a minimum SOC value of TMCS,
$${SOC}_{ω}^{t}$$
represents a SOC value of TMCS ω at time t, and
$${SOC}_{ω}^{t + 1}$$
represents a SOC value of TMCS ω at time t+1.

4. The method according to claim 3, wherein an objective function of the multi-period optimization decision model is shown as a formula (13):
$${max}_{{x}^{t}} f ( {x}^{t} ) = {\sum }_{t ∈ T} {\sum }_{ω ∈ Ω} \{ R ( {x}^{t} ) - {C}^{OM} ( {x}^{t} ) - {C}^{DEG} ( {x}^{t} ) \} \qquad ( 13 )$$
$$R ( {x}^{t} ) = {α}_{m}^{tmc} {P}_{dch , ω m}^{t} + {λ}_{n}^{t , d} {P}_{dch , ω n}^{t} - {λ}_{n}^{t , c} {P}_{ch , ω n}^{t} \qquad ( 14 )$$
$${C}^{OM} ( {x}^{t} ) = {λ}_{n}^{{t}_{e} , c} {c}_{tmc} {D}_{ω} + {c}^{la} + {c}^{mt} \qquad ( 15 )$$
$${C}^{DEG} ( {x}^{t} ) = {c}^{mdc} + ( 1 + {r}_{0} ) κ ( t ) \{ {P}_{dch , ω m}^{t} + {P}_{dch , ω n}^{t} + {P}_{ch , ω n}^{t} + {q}^{t} \} \qquad ( 16 )$$
wherein, x^{t} is a decision variable,
$${α}_{m}^{tmc}$$
is a charging service fee,
$${λ}_{n}^{t , c}$$
is an energy arbitrage charging price,
$${λ}_{n}^{t , d}$$
is an energy arbitrage discharging price,
$${λ}_{n}^{{t}_{e} , c}$$
is a charging price when the TMCS ends operation and gets charged, c_{tmc} is an energy consumption per kilometer of TMCS, c^{la} is a labor cost converted to time t, c^{mt} is a maintenance cost converted to time t, c^{mdc} is a life-cycle marginal degradation cost to achieve the maximum life-cycle revenue of TMCS, q^{t} is a calendar degradation parameter of TMCS battery packs, r₀ is a discount rate, and κ(t) is a year order of time t since TMCS was put into service.

5. The method according to claim 4, wherein in step S2, the MDP comprises a state variable S^{t}, a decision variable x^{t}, and an exogenous variable W^{t}, and state variables in two successive stages are linked by a transit function; the state variable reflects a current state of system, as shown in a formula (17):
$${S}^{t} = \{ {SOC}_{ω}^{t} , {ζ}_{ω , mu}^{t - Δ t} , {ζ}_{ω , nv}^{t - Δ t} , {ζ}_{ω , mn}^{t - Δ t} , {P}_{m}^{t} \} \qquad ( 17 )$$
$${ζ}_{ω , mu}^{t - Δ t} , {ζ}_{ω , nv}^{t - Δ t} , and {ζ}_{ω , mn}^{t - Δ t} .$$
are all binary variables, and
$${ζ}_{ω , mu}^{t - Δ t} = 1$$
if TMCS ω is located between the nodes m and u at a previous period of time t,
$${ζ}_{ω , nv}^{t - Δ t} = 1$$
if TMCS ω is located between the nodes n and v at a previous period of time t,
$${ζ}_{ω , mn}^{t - Δ t} = 1$$
if TMCS ω is located between the nodes m and n at a previous period of time t,
$${ζ}_{ω , mu}^{t - Δ t} = 0$$
if TMCS ω is not located between the nodes m and u at a previous period of time t,
$${ζ}_{ω , nv}^{t - Δ t} = 0$$
if TMCS ω is not located between the nodes n and v at a previous period of time t, and
$${ζ}_{ω , mn}^{t - Δ t} = 0$$
if TMCS ω is not located between the nodes m and n at a previous period of time t,
$${P}_{m}^{t}$$
is a EV charging load at node m at time t, and
$${SOC}_{ω}^{t}$$
represents a SOC value of TMCS ω at time t;
in the MDP, the decision variable x^{t} is denoted as:
$${x}^{t} = \{ {P}_{ch , ω n}^{t} , {P}_{dch , ω n}^{t} , {P}_{dch , ω m}^{t} , {ζ}_{ω , mu}^{t} , {ζ}_{ω , nv}^{t} , {ζ}_{ω , mn}^{t} , {I}_{ch , ω}^{t} , {I}_{dch , ω}^{t} \} \qquad ( 18 )$$
exogenous information is employed to model the error between the predicted and actual values of uncertain factors, and main sources of uncertainty comprise EV charging demand, adjustments in charging fees, and energy arbitrage price fluctuations, the exogenous information W^{t} is defined as:
$${W}^{t} = \{ {\hat{P}}_{m}^{t} , {α}_{m}^{tmc} , {λ}_{n}^{t , d} , {λ}_{n}^{t , c} \} \qquad ( 19 )$$
wherein,
$${\hat{P}}_{m}^{t}$$
is a predicted value of
$${P}_{m}^{t} ;$$
from time perspective, W^{t} denotes a stochastic information obtained after an end of a previous period (t−Δt) and before the current decision x^{t} is made, therefore, a evolution of decision process is as (W^{t}, S^{t}, x^{t}, W^{t+Δt}, S^{t+Δt} x^{t+Δt}, . . . ), wherein, W^{t+Δt}, S^{t+Δt} and x^{t+Δt} are an exogenous variable at a next period of time t, a state variable at the next period of time t, and a decision variable at the next period of time t, respectively; the transition function refers to a process by which the system transfers from the current state S^{t} to a next state S^{t+Δt} based on the decision x^{t} and the exogenous information W^{t+Δt}, therefore, the transition function is defined as follows to obtain a state information of the system for the next time period.
$${S}^{t + Δ t} ( 1 ) = {S}^{t} ( 1 ) + \frac{Δ t}{{E}_{ω}} \{ {η}_{ch , ω} {\sum }_{n ∈ {M}_{a}} {x}^{t} ( 1 ) - ( {\sum }_{n ∈ {M}_{a}} {x}^{t} ( 2 ) + {\sum }_{m ∈ {M}_{c}} {x}^{t} ( 3 ) ) / {η}_{dch , ω} \} \qquad ( 20 )$$
$${S}^{t + Δ t} ( 2 ) = {x}^{t} ( 4 ) \qquad ( 21 )$$
$${S}^{t + Δ t} ( 3 ) = {x}^{t} ( 5 ) \qquad ( 22 )$$
$${S}^{t + Δ t} ( 4 ) = {x}^{t} ( 6 ) \qquad ( 23 )$$
$${S}^{t + Δ t} ( 5 ) = {P}_{m}^{t + Δ t} + {W}^{t + Δ t} ( 1 ) \qquad ( 24 )$$
wherein, Δt is a time interval, number in brackets of S^{t+Δt}(·) and S^{t}(·) corresponds to an order of parameter of S^{t} in the formula (17), S^{t+Δt}(·) and S^{t}(·) refer to parameters in corresponding position of S^{t}; number in brackets of x^{t} (·) corresponds to an order of parameter of x^{t} in the formula (18), x^{t}(·) refers to a parameter in corresponding position of x^{t}; number in brackets of W^{t+Δt} (·) corresponds to an order of parameter of W^{t+Δt} in the formula (19), W^{t+Δt}(·) refers to a parameter in corresponding position of W^{t+Δt}, therefore, the formula of the objective function (13) is reformulated as:
$$F = {max}_{{x}^{t} ∈ {X}^{t}} E [ {\sum }_{t ∈ T} {f}^{t} ( {S}^{t} , {x}^{t} ) ] \qquad ( 25 )$$
$${f}^{t} ( {S}^{t} , {x}^{t} ) = R ( {S}^{t} , {x}^{t} ) - {C}^{OM} ( {S}^{t} , {x}^{t} ) - {C}^{DEG} ( {S}^{t} , {x}^{t} ) \qquad ( 26 )$$
wherein, E{·} represents performing expectation calculation, X^{t} represents a set of possible decisions, after reformulating the multi-period optimization decision model for TMCSs as the MDP, an optimal decision sequence is obtained through the DP method by solving a Bellman equation:
$${V}^{t} ( {S}^{t} ) = {max}_{{x}^{t} ∈ {X}^{t}} \{ {f}^{t} ( {S}^{t} , {x}^{t} ) + γ E [ {V}^{t + Δ t} ( {S}^{t + Δ t} ) \vert {S}^{t} , {x}^{t} ] \} \qquad ( 27 )$$
wherein, V^{t}(S^{t}) is a value function, indicating a cumulative reward of the system in state S^{t} over the time interval Δt; ƒ^{t} represents the objective function, and γ is a discount factor that affects a weight of immediate and future rewards in the MDP, γ is set between 0 and 1.

6. The method according to claim 5, wherein in step S3, a value function of a post-decision state is:
$${V}^{t} ( {S}^{t} ) = {max}_{{x}^{{t}_{1}} , {x}^{{t}_{1} + Δ t} , … , {x}^{{t}_{1} + ( H - 1 ) Δ t}} \{ {\sum }_{t = {t}_{1}}^{{t}_{1} + ( H - 1 ) Δ t} {f}^{t} ( {S}^{t} , {x}^{t} ) + γ {V}_{x}^{{t}_{1} + H Δ t} ( {S}_{x}^{{t}_{1} + H Δ t} ) \} \qquad ( 28 )$$
$${V}_{x}^{{t}_{1} + H Δ t} ( {S}_{x}^{{t}_{1} + H Δ t} ) = E [ {V}^{{t}_{1} + H Δ t} ( {S}^{{t}_{1} + H Δ t} ) \vert {S}^{{t}_{1} + ( H - 1 ) Δ t} ] . \qquad ( 29 )$$
Wherein,
$${S}_{x}^{t}$$
represents a state variable after the decision;
$${V}_{x}^{t} ( \cdot )$$
represents a value function of state after the decision, which denotes a state of the system after a decision is executed but before any random information is received, the Bellman equation is rewritten as a piecewise linear function (PLF) with monotonically increasing slopes:
$${V}_{x}^{{t}_{1} + H Δ t} ( {S}_{x}^{{t}_{1} + H Δ t} ) \approx {\overline{V}}_{x}^{{t}_{1} + H Δ t} ( {SOC}_{x}^{{t}_{1} + H Δ t} ) = {\sum }_{ω ∈ Ω , a ∈ {N}^{a}} {d}_{a , ω}^{{t}_{1}} {r}_{a , ω}^{{t}_{1}} \qquad ( 30 )$$
wherein, N^{a} represents a total number of segments in PLF
$${\overline{V}}_{x}^{t} ( \cdot )$$
and a is a segment index;
$${SOC}_{x}^{t + H Δ t}$$
denotes a SOC value of TMCS after the decision; H is a rolling horizon length set based on a reliability of short-term forecasts;
$${d}_{a , ω}^{{t}_{1}}$$
represents a slope for segment a of PLF;
$${r}_{a , ω}^{{t}_{1}}$$
represents a length of
$${SOC}_{x}^{t + Δ t}$$
projected onto a horizontal axis;
$${\overline{{V}_{x}}}^{t} ( \cdot )$$
is divided into N^{a} segments, thus:
$${SOC}_{ω , x}^{{t}_{1} + H Δ t} = {\sum }_{a ∈ {N}^{a}} {r}_{a , ω}^{{t}_{1}} / {E}_{ω} \qquad ( 31 )$$
$$0 \leq {r}_{a , ω}^{{t}_{1}} \leq ( {E}_{ω}^{max} - {E}_{ω}^{min} ) / {N}^{a} \qquad ( 32 )$$
$${d}_{a , ω}^{{t}_{1}} \leq {d}_{a + 1 , ω}^{{t}_{1}} \qquad ( 33 )$$
$${SOC}_{ω}^{{t}_{1}} = {SOC}_{ω , x}^{{t}_{1} + H Δ t} + {\sum }_{t = {t}_{1}}^{{t}_{1} + ( H - 1 ) Δ t} \{ ( {\sum }_{n ∈ {M}_{a}} {P}_{dch , ω n}^{t} + {\sum }_{m ∈ {M}_{c}} {P}_{dch , ω m}^{t} ) / {η}_{dch , ω} - {η}_{ch , ω} {\sum }_{n ∈ {M}_{a}} {P}_{ch , ω n}^{t} \} / {E}_{ω} \qquad ( 34 )$$
wherein,
$${E}_{ω}^{max} and {E}_{ω}^{min}$$
refer to maximum and minimum energy storage capacity of TMCS ω, respectively; t₁ is a start time period;
$$S O {C}_{ω}^{{t}_{1}}$$
denotes a SOC of TMCS ω before the decision x^{t}^{₁} is executed; the formula (31) indicates that the TMCS energy equals a sum of the values in each segment; the formula (32) ensures that the values in each segment do not exceed an upper and lower limits; the formula (33) ensures that the slope increases monotonically with the segment number, thereby guaranteeing that PLF is a convex function; the formula (34) represents a change relationship of SOC of TMCS ω before and after the decision, and an approximate optimal decision x̅^{t}^{₁} is obtained by recursively solving following formula:
$${\overline{x}}^{{t}_{1}} = arg$$
$${max}_{{x}^{{t}_{1}} , {x}^{{t}_{1} + Δ t} , … , {x}^{{t}_{1} + ( H - 1 ) Δ t}} ( {\sum }_{t = {t}_{1}}^{{t}_{1} + ( H - 1 ) Δ t} {f}^{t} ( {S}^{t} , {x}^{t} ) + γ {\sum }_{ω ∈ Ω , a ∈ {N}^{a}} {d}_{a , ω}^{{t}_{1} + H Δ t} {r}_{a , ω}^{{t}_{1} + H Δ t} \vert {S}_{x}^{{t}_{1} + ( H - 1 ) Δ t} ) . \qquad ( 35 )$$

7. The method according to claim 6, wherein a differential iteration method is employed to train and update the slopes of PLF segments, after the (k−1)-th iteration, the PLF function
$${\overline{V}}_{x}^{{t}_{1} + H Δ t , k - 1}$$
corresponding to each time period is known, thus, the formula (35) in the k-th iteration is rewritten as formula (36), then a slope sample value of
$${\overline{V}}_{x}^{{t}_{1} , k}$$
is defined as formula (37), and the slope of the PLF is updated as formula (38):
$${\overline{x}}_{k}^{{t}_{1}} = arg$$
$${max}_{{x}_{k}^{{t}_{1}} , {x}_{k}^{{t}_{1 + Δ t}} , … , {{x}_{k}^{{t}_{1}}}^{+ ( H - 1 ) Δ t}} ( {\sum }_{t = {t}_{1}}^{{t}_{1} + ( H - 1 ) Δ t} {f}^{t} ( {S}_{k}^{t} , {x}_{k}^{t} ) + γ {\sum }_{ω ∈ Ω , a ∈ {N}^{a}} {d}_{a , ω , k - 1}^{{t}_{1} + H Δ t} {r}_{a , ω , k}^{{t}_{1} + H Δ t} \vert {S}_{x , k}^{{t}_{1} + ( H - 1 ) Δ t} ) \qquad ( 36 )$$
$${\hat{d}}_{a , k}^{{t}_{1}} ( {SOC}_{x , k}^{{t}_{1}} ) = \partial {max}_{{x}^{{t}_{1}} , {x}^{{t}_{1 + Δ t}} , … , {{x}^{{t}_{1}}}^{+ ( H - 1 ) Δ t}} ( {\sum }_{t = {t}_{1}}^{{t}_{1} + ( H - 1 ) Δ t} {f}^{t} ( {S}_{k}^{t} , {x}_{k}^{t} ) + γ {\sum }_{ω ∈ Ω , a ∈ {N}^{a}} {d}_{a , ω , k - 1}^{{t}_{1} + H Δ t} {r}_{a , ω , k}^{{t}_{1} + H Δ t} ) / \partial {SOC}_{k}^{{t}_{1}} \qquad ( 37 )$$
$${d}_{a , k}^{{t}_{1}} ( {SOC}_{x , k}^{{t}_{1}} ) = ( 1 - {θ}_{k - 1} ) {d}_{a , k - 1}^{{t}_{1}} ( {SOC}_{x , k}^{{t}_{1}} ) + {θ}_{k - 1} {\hat{d}}_{a , k}^{{t}_{1}} ( {SOC}_{x , k}^{{t}_{1}} ) \qquad ( 38 )$$
wherein,
$${\overline{x}}_{k}^{{t}_{1}}$$
represents the approximate optimal decision in the k-th iteration;
$${d}_{a , k - 1}^{t} ( {SOC}_{x , k}^{t} )$$
denotes the slope value of segment a in the PLF at the (k−1)-th iteration;
$${\hat{d}}_{a , k}^{{t}_{1}} ( {SOC}_{x , k}^{{t}_{1}} )$$
represents a gradient of the state variable at k-th iteration; and θₖ₋₁ is an updating interval of the slope; the slope of PLF represents an impact of TMCS unit energy changes on a subsequent period profit of CFO, to ensure that the updated slopes still satisfy the monotonically increasing property, a leveling algorithm is employed to update the slope values of each segment:
$${d}_{b , k}^{{t}_{1}} = \{ \begin{matrix}max \{ {d}_{b , k - 1}^{{t}_{1}} , ( 1 - {θ}_{k - 1} ) {d}_{a , k - 1}^{{t}_{1}} + {θ}_{k - 1} {\hat{d}}_{a , k}^{{t}_{1}} \} , b > a \\ ( 1 - {θ}_{k - 1} ) {d}_{a , k - 1}^{{t}_{1}} + {θ}_{k - 1} {\hat{d}}_{a , k}^{{t}_{1}} , b = a \\ min \{ {d}_{b , k - 1}^{{t}_{1}} , ( 1 - {θ}_{k - 1} ) {d}_{a , k - 1}^{{t}_{1}} + {θ}_{k - 1} {\hat{d}}_{a , k}^{{t}_{1}} \} , b < a\end{matrix} \qquad ( 39 )$$
wherein,
$${d}_{b , k}^{{t}_{1}}$$
represents a slope corresponding to segment b after the k-th iteration.

8. The method according to claim 1, wherein in step S1, constructing the multi-period optimization decision model for TMCSs comprises:
Obtaining road network information, power grid information, and TMCS configuration information, wherein the road network information comprises locations of charging service nodes; the power grid information comprises locations of energy arbitrage nodes; and the TMCS configuration information comprises a current position of a TMCS, an average speed of the TMCS, and a final service location of the TMCS;
determining, based on the TMCS configuration information, the road network information, and the power grid information, a current operating state of the TMCS and a total travel distance within a scheduling period, wherein the operating state comprises providing EV charging service at a charging service node, performing energy arbitrage at an energy arbitrage node, and moving between nodes;
generating, based on the current operating state of the TMCS, a multi-period optimization decision model for TMCSs.

9. The method according to claim 8, wherein constructing the multi-period optimization decision model for TMCSs further comprises:
obtaining a charging and discharging data of the TMCS, an EV charging demand satisfied ratio of CFO, and an EV charging load, wherein the charging and discharging data comprises: a maximum charging power of a TMCS, a maximum discharging power of the TMCS, a maximum output power of the TMCS while providing EV charging service, a capacity of the TMCS, a charging efficiency of the TMCS, a discharging efficiency of the TMCS, a maximum SOC value of the TMCS, and a minimum SOC value of the TMCS;
determining, based on the operating state of the TMCS at a current time, a charging/discharging status of the TMCS at the current time;
determining, based on the EV charging demand satisfied ratio of CFO, the EV charging load, the charging and discharging data of the TMCS, and the charging/discharging status of the TMCS at the current time, following parameters: a charging power of the TMCS during energy arbitrage at the current time, a discharging power of the TMCS during energy arbitrage at the current time, an output power of the TMCS during EV charging service at the current time, a SOC value of the TMCS at the current time, and a SOC value of the TMCS at the subsequent time.

10. The method according to claim 9, wherein after constructing the multi-period optimization decision model for TMCSs, the method further comprises:
obtaining cost information and cost parameters, wherein the cost information comprises: a charging service fee, a charging price for energy arbitrage, a discharging price for energy arbitrage, and an charging price for TMCS at the end of operation; the cost parameters comprise: an energy consumption per kilometer of the TMCS, a labor cost, a maintenance cost, a life-cycle marginal degradation cost of the TMCS, a calendar degradation parameter of TMCS battery packs, a discount rate, and a year order corresponding to when the TMCS was put into service
determining, based on the cost information, the cost parameters, the charging power and discharging power of the TMCS during energy arbitrage, the output power of the TMCS during EV charging service, and the total travel distance of the TMCS within the scheduling period, a total revenue, an O&M cost, and a degradation cost;
optimizing the multi-period optimization decision model for TMCSs based on the total revenue, the O&M cost, and the degradation cost, so as to maximize the profit of the CFO.

11. The method according to claim 10, wherein in step S2, modeling MDP comprises:
obtaining a current state variable, a current decision variable, and next-period exogenous information, wherein the current state variable comprises: a SOC value of the TMCS at a current time, a TMCS location in a previous period, and an EV charging load at the current time; the current decision variable comprises: a charging power of TMCS while performing energy arbitrage at the current time, a discharging power of TMCS while performing energy arbitrage at the current time, an output power of TMCS while providing EV charging service at the current time, an operating state of TMCS at the current time, and a charging/discharging state of TMCS at the current time; the next-period exogenous information comprises: an estimated EV charging load at a next-period, a charging service fee at the next-period, a discharging price for energy arbitrage at the next-period, and a charging price for energy arbitrage at the next period;
obtaining, based on the current state variable, the current decision variable, and the next-period exogenous information, a next-period state variable;
reformulating the multi-period optimization decision model for TMCSs to model the MDP, and solving a Bellman equation via dynamic programming to obtain an optimal decision sequence.

12. The method according to claim 11, wherein in step S3, defining a post-decision value function to quantify an impact of current decisions on CFO's future profit, comprises:
obtaining, based on the current state variable, the current decision variable, the next-period exogenous information and the next-period state variable, a value function of state after decision;
approximating the value function of state after decision and obtaining a PLF with monotonically increasing slopes;
generating, based on a segments number of the PLF, maximum and minimum electric storage capacity of TMCS, SOC of TMCS and present rolling horizon length, constraints of the PLF, and recursively calculating to obtain an optimal decision.

13. The method according to claim 12, wherein recursively calculating to obtain an optimal decision comprises:
adopting a differential iteration method to train and update the slopes of PLF to indicate an impact of TMCS unit energy changes on a subsequent period profit of CFO;
updating, based on the updated slopes, slope values of each segment by a leveling algorithm to ensure that the updated slopes still satisfy the monotonically increasing property.
